(19) United States
(12) Patent Application Publication
(10) Pub. No.: US 2025/0381625 A1
(43) Pub. Date: Dec. 18, 2025

(54) Cleaning Laser Assembly and Method for Removing an Asbestos-Containing Material Cover Layer from Metallic Surfaces

(71) Applicant: Glatt Gesellschaft mit beschränkter Haftung, Binzen (DE)

(72) Inventors: Reinhard Nowak, Lörrach (DE); Eckhardt Krebs, Witterda (DE); Michael Grimann, Kassel (DE)

(21) Appl. No.: 18/881,056

(22) PCT Filed: Jun. 28, 2023
(86) PCT No.: PCT/EP2023/067647

§ 371 Date: Jan. 3, 2025

(30) Foreign Application Priority Data
Jul. 5, 2022 (DE) 10 2022 116 782.8

(51) Int. Cl. B23K 26/402

(52) U.S. Cl. CPC B23K 26/402

(57) ABSTRACT

A cleaning laser assembly and a method for removing asbestos-containing material cover layer from metallic surfaces. The cleaning laser assembly includes a cleaning laser that emits a laser beam and a suction device that has a auction opening.

### CROSS-REFERENCE TO RELATED APPLICATIONS

This application is the United States national phase of International Patent Application No. PCT/EP2023/067647 filed Jun. 28, 2023, and claims priority to German Patent Application No. 10 2022 116 782.8 filed Jul. 5, 2022, the disclosures of which are hereby incorporated by reference in their entireties.

### BACKGROUND

### Field

The invention relates to a cleaning laser assembly for removing an asbestos-containing material comprising cover layer from metallic surfaces during a cleaning process.

Furthermore, the invention relates to a method for removing an asbestos-containing material cover layer from metallic surfaces during a cleaning process, wherein during the cleaning process an asbestos fiber concentration at the workplace in the layer average is below an asbestos fiber acceptance concentration of 10,000 asbestos fibers/m³ during a cleaning process, as an abbreviation 10,000 F/m³.

### Description of Related Art

Asbestos is classified as a carcinogenic hazardous substance in accordance with Annex VI of Regulation (EC) No. 1272/2008 and the Hazardous Substances Ordinance (GefStoffV) (category 1A) and is subject to a general ban on use. The only exception to this is demolition, renovation and maintenance work in accordance with GefStoffV Annex II No. 1.

Asbestos is defined as the following fibrous silicates: actinolite, amosite, antophyllite, chrysotile, crocidolite and tremolite.

Asbestos-containing materials are mixtures and articles that contain asbestos and for which an activity can lead to the formation or release of fibrous dusts.

The protective measures required under Annex I No. 2.4 of the Hazardous Substances Ordinance and the organizational requirements for permitted activities involving asbestos or asbestos-containing materials are summarized and specified in the Technical Rules for Hazardous Substances TRGS 519 “Asbestos-Demolition, Renovation or Maintenance Work” in the version dated Mar. 31, 2022. In the following, this version will always be referred to when the TRGS 519 is mentioned. Protecting employees usually also ensures the protection of third parties and the environment.

A high level of exposure to asbestos fibers is assumed for all activities involving asbestos (worst case), so that all requirements of Annex I No. 2.4 GefStoffV must be implemented as a rule. This applies in particular to:
Possession of certain qualifications/expertise in accordance with TRGS 519
Regular implementation of occupational health precautions
Adherence to restrictions on employment
Special construction site facilities such as airlocks for personnel and materials
Technical ventilation measures, negative pressure maintenance
Wearing personal protective equipment

For activities involving asbestos that lead to low-level exposure, the Hazardous Substances Ordinance allows deviations from these requirements in Annex I No. 2.1.

In connection with the risk concept for carcinogenic substances of the TRGS 910, activities with low exposure or low risk are those for which it has been demonstrated that the asbestos fiber concentration at the workplace is below the asbestos fiber acceptance concentration of 10,000 asbestos fibers/m³ as a shift average.

“Low-emission methods” according to TRGS 519 No. 2.9 are those activities with low exposure that have been tested and approved by the authorities or by the statutory accident insurance providers. A low-emission method is based on a standardized working procedure for which it has been proven that it is well below the asbestos acceptance concentration.

If the limit values for other hazardous substances, e.g. mineral dust, quartz-containing dust, emissions from materials containing tar, which may also be released during the process, are not complied with, the process description must include appropriate protective measures.

For the statutory accident insurance providers, the testing and approval of low-emission methods according to TRGS 519 is carried out by the “Construction” department of the German Social Accident Insurance (DGUV) under the leadership of the DGUV working group “Low-emission methods according to TRGS 519 for activities involving asbestos-containing materials”.

### SUMMARY

The object of the invention is therefore to provide both a cleaning laser assembly and a method for removing an asbestos-containing material cover layer from metallic surfaces, wherein the cleaning laser assembly is suitable for carrying out the method, in particular as a low-emission method according to TRGS 519.

In a cleaning laser assembly of the type mentioned above, this task is accomplished by the cleaning laser assembly comprising a cleaning laser having a laser optic emitting a laser light and an cleaning laser comprising a laser optic emitting a laser light and a suction device comprising a suction opening, wherein during the cleaning process the cover layer of the metallic surface can be removed by the laser light emitted by the laser optic, so that the asbestos-containing material can be at least partially released, wherein the suction opening is arranged adjacent to the cleaning laser so that the removed cover layer can be sucked in together with the released asbestos-containing material through the suction opening into the suction device. In this case, the removal of the cover layer means that the laser light emitted by the laser optics vaporizes and/or burns and/or blasts the cover layer of the metallic surface. Advantageously, the cleaning laser assembly provides a very efficient method of removing an asbestos-containing material comprising a cover layer from metallic surfaces during a cleaning process, which releases a minimal asbestos fiber concentration, so that the activities in the work area are only exposed to a low level of asbestos. It is expediently possible to even achieve a low-emission method according to TRGS 519 with the cleaning laser assembly.

Preferably, the suction device should also comprise a TRGS 519 asbestos license.

Activities with low exposure are low-risk works as defined in Technical Rules for Hazardous Substances 910, in which the asbestos concentration remains below the acceptable concentration of 10,000 asbestos fibers/m³ (for information on how to determine the asbestos fiber concentration, see number 4.3 paragraph 1, Technical Rules for Hazardous Substances 519 in the version dated Mar. 31, 2022). If such activities are carried out inside buildings, it must be demonstrated after completion of all work that the asbestos fiber concentration in the room air is below 500 F/m³ and an upper Poisson value of 1,000 F/m³ (measurement according to VDI 3492).

The term “low-emission methods” includes those activities according to 2.8 of the TRGS 519 that have been tested and approved by the authorities or by the statutory accident insurance institutions. The basis for the corresponding test are the assessment criteria established by the Institute for Occupational Safety and Health of the German Statutory Accident Insurance (IFA). The methods recognized by the statutory accident insurance institutions are published in BGI 664 with current additions (see www.dguv.de) (to determine the asbestos fiber concentration as part of the method test, see TRGS 519, number 4.3, paragraph 2).

In a cleaning laser assembly that is advantageous in this respect, the cleaning laser is designed as an Nd: YAG solid-state laser.

According to an additional advantageous embodiment of the cleaning laser assembly, the power density of the cleaning laser comprises single-pulse powers in the range of several hundred kilowatts. It is expediently the case that the single-pulse powers are greater than 200 kW, preferably greater than 500 kW, more preferably greater than 1,000 kW. The high power densities make removal economically viable.

According to a further advantageous embodiment of the cleaning laser assembly, the suction device comprises a collecting device for the suctioned, asbestos-containing material. The asbestos fibers released and suctioned off by the laser removal and collected separately by the collecting device, which is designed, for example, in the manner of a vacuum cleaner bag. Laser ablation, also known as laser vaporization, is the removal of a cover layer from a surface by means of pulsed laser light, also known as laser radiation. The laser light used here has a high power density, which leads to rapid heating and the formation of a plasma on the surface.

In this regard, the collecting device of the suction device is replaceable. It is further preferred that the collecting device can be closed before replacement, thus preventing the release of asbestos fibers during replacement. The replaceable collecting device makes it easy to continue working without losing much time and to dispose of the asbestos fibers in accordance with regulations.

Furthermore, the suction device comprises a filter device, the filter device being expediently designed as a HEPA filter. The filter device can be used to clean the extracted air with the removed cover layer and the released asbestos fibers. HEPA filters (High Efficiency-Particulate Air filters) are filters that are suitable for removing over 99.9 percent of all dust particles larger than 0.1-0.3 micrometers (μm) such as viruses, respirable dusts, mite eggs and excrement, pollen, smoke particles, asbestos, bacteria, various toxic dusts and aerosols from the air.

The filter device preferably also comprises a filter vibrating unit. The filter vibrating unit makes it possible to clean the filter device of the asbestos fibers that collect on the filter device and to collect the asbestos fibers, for example, in the collecting device. It is expedient to design the filter vibrating unit as a manually, mechanically operated filter vibrating unit.

The cleaning laser assembly advantageously comprises the suction device, which comprises a suction power of greater than 3 kW, preferably greater than 5 kW, more preferably greater than 7 kW. Suction powers of this magnitude ensure that the asbestos fibers are safely extracted during the cleaning process. The suction device is preferably designed as a vacuum suction device. The vacuum pressure prevailing in the suction device ensures that the asbestos fibers, once extracted, remain in the suction device's collecting device.

According to an additional advantageous embodiment of the cleaning laser assembly, the cleaning laser assembly comprises a housing, wherein the housing is designed in such a way that the cleaning laser remains asbestos-free during the cleaning process. In this regard, the housing is designed as a casing. Furthermore, it is possible to design the housing from a tubular film comprising a defined thickness, expediently from a 100 μm thick LDPE tubular film. Other tubular films with thicknesses in the range of 50 μm to 250 μm, for example, are also conceivable. The housing ensures that the cleaning laser is not exposed to the asbestos, so that it can continue to be used for other applications outside the asbestos area.

Furthermore, the cleaning laser assembly comprises a control device with closed loop control functionality, which is expediently configured to automatically adapt a suction flow of the suction device to a parameterization of the cleaning laser. It is advantageous to adapt the suction device because, for example, more asbestos fibers may be released under certain circumstances with a higher energy density and a shorter pulse length. In particular, a higher power density and/or shorter pulse length can lead to stronger suction. The control device automatically adapts the suction flow of the suction device for an optimized setting.

The control device is advantageously configured to trigger a run-on of the suction device after termination of the cleaning process. This ensures that after the cleaning process has been stopped, the suction device continues to extract the working area for a certain time, whereby any asbestos fibers that may still be released and not sucked in are also extracted.

According to a favorable embodiment of the cleaning laser assembly, the cleaning assembly comprises a holding device on which the cleaning laser can be arranged in such a way that the latter is always at the same distance from the metallic surface comprising the cover layer. If the distance to the metallic surface is always the same, it is sufficient to parameterize the cleaning laser before the cleaning process. Furthermore, it is easier to control the motion of the cleaning arrangement during the cleaning process. Moreover, the workload for the operator is also reduced. It is expediently designed as an industrial robot.

In addition, the task is accomplished by means of a method of the type mentioned above in that the cover layer is removed by means of a cleaning laser assembly which comprises a cleaning laser that emits a laser beam and which comprises a suction device that has a suction opening. In addition, the task is accomplished by means of a method of the type mentioned above in that the cover layer is removed by means of a cleaning laser assembly which comprises a cleaning laser that emits a laser beam and which comprises a suction device that has a suction opening. The level of asbestos fiber exposure is to be determined by workplace measurements in accordance with TRGS 402 in conjunction with DIN EN 689. This is described by the result of the measurement of the average asbestos fiber concentration (shift average) over an 8-hour shift. Removing the cover layer using a cleaning laser assembly is a very efficient method of removing an asbestos-containing material comprising a cover layer from metallic surfaces during a cleaning process, which releases only a minimal asbestos fiber concentration, so that the activities in the work area are only exposed to a low level of asbestos. A method advantageous in this regard is a low-emission method according to TRGS 519.

According to an additional advantageous method, the removed cover layer is sucked in together with the released asbestos-containing material through a suction opening into the suction device during the cleaning process. This ensures that asbestos fibers are only released in a low asbestos fiber concentration.

In addition, in this advantageous method, the cleaning laser is designed as a Nd: YAG solid-state laser and emits an invisible infrared laser light, also referred to as laser radiation. The infrared laser light is preferably emitted at a wavelength of 1,064 nm. Surprisingly, it has been found that a Nd: YAG solid-state laser with an emitted wavelength of 1064 nm provides optimized ablation results for the asbestos-containing material from the cover layer.

In an additional preferred embodiment of the method, the power density of the cleaning laser assembly comprises single-pulse powers in the range between 200 kW and 2000 kW and the pulse lengths are in the range from 50 ns to 200 ns. Due to the combination of power density and pulse length in the above-mentioned ranges, significant heating of the surface occurs during the pulse. Preferably, the power density is a few hundred kilowatts, especially between 200 kW and 500 kW. Since heat conduction into the volume of the cover layer is comparatively slow, the rapidly applied heat usually cannot dissipate. Thus, the surface of the cover layer comprising the asbestos-containing material is heated to such an extent that it turns into plasma. This plasma can become so dense that it absorbs a large portion of the laser light, thus protecting the surface below from further heating. This results in optimized ablation of the cover layer by the cleaning laser assembly.

In accordance with a further advantageous method, the suction device comprises a filter device, wherein the filter device further comprises a filter vibrating unit suitable for cleaning the filter device. This ensures that the filtering of the extracted and removed cover layer together with the asbestos-containing materials can always be carried out in an optimized manner, and that the filter device does not become clogged with asbestos fibers, for example.

According to an additional preferred embodiment of the method, the cleaning laser assembly comprises a control device that has closed-loop control functionality and is configured to automatically adapt a suction flow of the suction device to a parameterization of the cleaning laser.

An adaption of the suction device is advantageous because, for example, more asbestos fibers may be released during the cleaning process by laser ablation at a higher energy density and a shorter pulse length. In particular, a higher power density and/or shorter pulse length can lead to stronger suction. The control device automatically adapts the suction flow of the suction device to the laser ablation in an optimized way.

The control device is advantageously configured to trigger a run-on of the suction device after termination of the cleaning process. This ensures that after the cleaning process has been stopped, the suction device continues to remove asbestos fibres from the work area for a certain period of time, thereby also extracting any asbestos fibres that may have been released but not yet sucked in. In this regard, the follow-up time is between 30 s and 10 min.

Furthermore, according to an additional embodiment of the preferred method, the cleaning laser assembly comprises a control device having closed loop control functionality, wherein the control device is configured to switch on the suction device when the cleaning laser is switched on. This ensures that the suction device is switched on during a cleaning process with the cleaning laser and that the removed cover layer is always sucked in together with the asbestos-containing material.

### BRIEF DESCRIPTION OF THE DRAWINGS

The terms Fig., Figs., Figure, and Figures are used interchangeably in the specification to refer to the corresponding figures in the drawings.

The invention is explained in more detail below, with reference to the accompanying drawings, in which

FIG. 1 shows a schematic illustration of an embodiment of a preferred cleaning laser assembly.

FIG. 1 shows a schematic illustration of an exemplary embodiment of a cleaning laser assembly 1 for removing a cover layer 3 comprising asbestos-containing materials 2 from metallic surfaces 4 during a cleaning process.

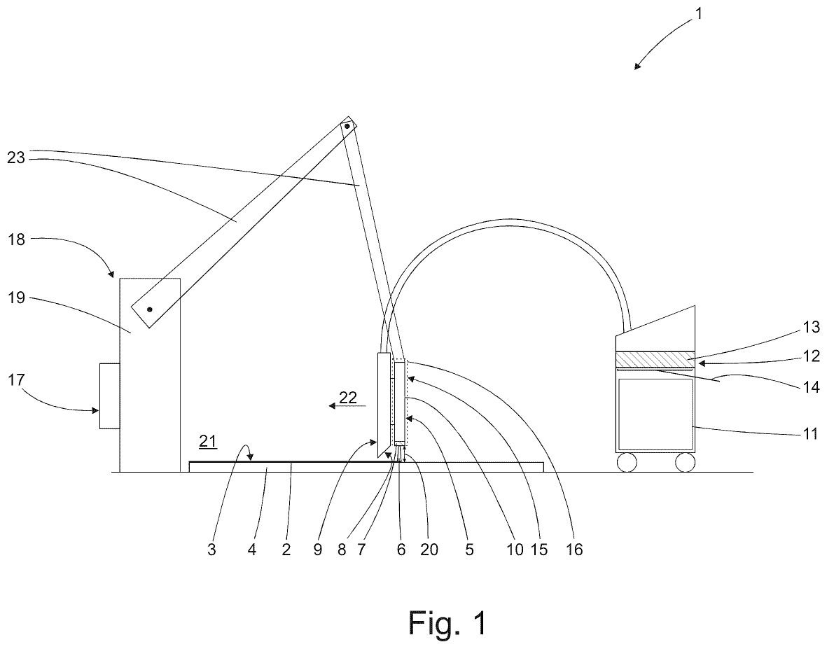

### DETAILED DESCRIPTION OF PREFERRED EMBODIMENTS

The following silicates with a fibrous structure are classified as asbestos: actinolite, amosite, antophyllite, chrysotile, crocidolite and tremolite.

Asbestos-containing materials 2 are mixtures and products that contain asbestos and whose use can lead to the creation or release of fibrous dust.

The cleaning laser assembly 1 comprises a cleaning laser 5, which has a laser optic 7 emitting a laser light 6, and a suction device 9 having a suction opening 8. The suction opening 8 is arranged adjacent to the cleaning laser 5 so that the cover layer 3 removed during the cleaning process by the laser light 6 emitted by the laser optics 7 is sucked in together with the at least partially released asbestos-containing material 2 through the suction opening 8 into the suction device 9.

In this method, the cover layer 3 is removed from the metallic surface 4 by means of pulsed laser light 6, forming a plasma. Expediently, the cleaning laser 5 is designed as an Nd: YAG solid-state laser 10. The Nd: YAG solid-state laser 10 emits non-visible infrared radiation at a wavelength of 1,064 nm. In principle, other cleaning lasers 5 with shorter emission wavelengths can also be used, but these are generally less efficient at removing the cover layer 3 comprising asbestos-containing material 2.

High power densities with single-pulse powers in the range of several hundred kilowatts are required to remove the cover layer 3 at economically viable ablation rates. The cleaning laser 5 used in the embodiment shown is a CL1000 laser cleaning system from Clean Lasersysteme GmbH with the OSH80 laser optic. The nominal power of the CL1000 laser cleaning system is 1,000 W, the single-pulse power density of the cleaning laser 5 used in the embodiment is in the range of several hundred kilowatts.

In an unrealized embodiment, a hand-held optic OSH80 or EffiScan and a quick-change fiber were used. The single-pulse power densities used were greater than 200 kW, in particular greater than 500 kW.

The pulse lengths are typically in the range of 50 ns to 200 ns. In the embodiment, a pulse length of the order of 100 ns was chosen so that significant heating of the surface 4 can take place during the pulse. Since heat conduction in the volume of the cover layer 4 is comparatively slow, the rapidly applied heat cannot be dissipated, so that the cover layer 3 heats up to such an extent that it transitions to the plasma state. This plasma can become so dense that it absorbs a large part of the laser light 6, thus protecting the underlying surface from further heating.

The suction device 9 is preferably designed as a vacuum suction device. In the embodiment, a DG50EXP asbestos suction device with asbestos approval according to TRGS519 from Delfin Industrial Vacuums is used as the suction device 9, which comprises a suction power of 5 kW.

In other embodiments, a suction power of 3 kW or 7 kW was used.

Furthermore, the suction device 9 comprises a collecting device 11 for the asbestos-containing material 2 that has been sucked in. Preferably, the collecting device 11 of the suction device 9 is replaceable. Furthermore, the collecting device is designed in such a way that it can be closed dust-tight during replacement, thus preventing asbestos-containing material 2 from escaping.

Moreover, the suction device 9 comprises a filter device 12, the filter device 12 being expediently designed as a HEPA filter 13 of filter class H14. In addition, a filter vibrating unit 14 is arranged on the filter device 12, which, when manually actuated, mechanically cleans the filter device 12.

In the embodiment shown, the cleaning laser assembly 1 comprises an optional housing 15. The housing 15 is designed so that the cleaning laser 5 does not come into contact with the asbestos-containing material 2 during the cleaning process, i.e. it remains asbestos-free. The housing 15 can optionally be designed, for example, as a casing 16, as shown in the embodiment, or as a tubular film. When using a tubular film, an LDPE tubular film with a thickness in the range of 50 μm to 200 μm, particularly preferably 100 μm, is used in sufficient length.

In the embodiment, the cleaning laser assembly 1 additionally comprises a control device 17 that comprises closed-loop control functionality. The control device 17 is configured, inter alia, to automatically adapt a suction flow of the suction device 9 to a parameterization and/or to trigger a run-on of the suction device 9 after termination of the cleaning process and/or to switch on the suction device 9 when the cleaning laser 5 is switched on. If the cleaning laser assembly does not comprise a control device 17, the suction device 9 should always be set to the maximum suction power.

Furthermore, cleaning laser assembly 1 comprises a holding device 18, on which the cleaning laser 5 can be arranged. The holding device 18, expediently a movable frame or, as shown in the embodiment, an industrial robot 19 comprising a plurality of robot arms 23 arranged movably relative to one another, ensures that the laser optics 6 of the cleaning laser 5 always have the same distance 20 from the metallic surface 4 comprising the cover layer 3. In addition, the holding device 18 can be used to ensure a defined motion 22 of the cleaning laser 5. This significantly improves the quality of the laser cleaning compared to a hand-held cleaning laser 5.

The method for removing an asbestos-containing material 2 cover layer 3 from metallic surfaces 4 during a cleaning process, wherein during the cleaning process an asbestos fiber concentration at the workplace in the shift average is below an asbestos fiber acceptance concentration of 10,000 F/m³, is characterized by the removal of the cover layer 3 by means of a cleaning laser assembly 5, which comprises a cleaning laser 5 emitting a laser light 6 and a suction device 9 comprising a suction opening 8. The suction device 9 is suitable for sucking the cover layer 3 vaporized during the cleaning process together with the released asbestos-containing material 2 into the suction device 9 through a suction opening 8. Expediently, the method is a low-emission method according to TRGS 519.

Activities involving low exposure are low-risk activities as defined in Technical Rule 910, in which the asbestos fiber acceptance concentration of 10,000 asbestos fibers/m³ (abbreviated F/m³) is not reached (for information on determining the asbestos fiber concentration, see number 4.3, paragraph 1 of Technical Rule 519). If such activities are carried out inside buildings, it must be demonstrated after completion of all work that a fiber concentration of 500 F/m³ and an upper Poisson value of 1000 F/m³ in the room air are not exceeded (measurement according to VDI 3492).

The term “low-emission methods” encompasses those activities according to number 2.8 of TGRS 519 that have been tested and approved by the authorities or by the statutory accident insurance providers. The basis for the corresponding test are the assessment criteria established by the Institute for Occupational Safety and Health of the German Statutory Accident Insurance (IFA). The methods recognized by the statutory accident insurance institutions are published in BGI 664 with current additions (see www.dguv.de) (to determine the asbestos fiber concentration as part of the method test, see number 4.3 paragraph 2, TRGS 519).

The cleaning laser assembly 1 preferably comprises a cleaning laser 5 that is designed as an Nd: YAG solid-state laser 10 and emits non-visible infrared radiation, wherein the infrared laser light 6, which is also referred to as infrared radiation, is expediently emitted at a wavelength of 1064 nm.

The power density of the cleaning laser assembly 1 comprises, in particular, single-pulse powers in the range between 200 kW and 2,000 kW and the pulse lengths are in the range of 50 ns to 200 ns. A power density of a few hundred kilowatts, in particular from 200 kW to 500 kW, is particularly advantageous at a pulse length in the range of 80 ns to 150 ns.

The suction device 9 comprises a filter device 12, wherein the filter device 12 further comprises a filter vibrating unit 14 which is suitable for cleaning the filter device 12. The filter device 12 can be cleaned manually as required or controlled by the control device. Such a cleaning can be triggered, for example, when the pressure loss occurring through the filter device 12, which can be detected in particular by measuring the pressure difference, rises above a threshold value.

Finally, the cleaning laser assembly 1 comprises a control device 17 that has closed-loop control functionality and is configured to automatically adapt a suction flow of the suction device 9 to a parameterization of the cleaning laser 5 and/or to triggering a run-on of the suction device 9 after termination of the cleaning process, wherein the run-on expediently runs between 30 s and 10 min and/or when switching on the cleaning laser 5, switching on the suction device 9.

1. A cleaning laser assembly for removing an asbestos-containing material comprising cover layer from metallic surfaces during a cleaning process, wherein the cleaning laser assembly comprises:
a cleaning laser having a laser optic emitting a laser light; and
a suction device comprising a suction opening,
wherein during the cleaning process the cover layer of the metallic surface can be removed by the laser light emitted by the laser optic, so that the asbestos-containing material can be at least partially released,
and wherein the suction opening is arranged adjacent to the cleaning laser so that the removed cover layer can be sucked in together with the released asbestos-containing material through the suction opening into the suction device.

2. The cleaning laser assembly according to claim 1, wherein the power density of the cleaning laser comprises single-pulse powers greater than 200 kW.

3. (canceled)

4. The cleaning laser assembly according to claim 1, wherein the suction device comprises a collecting device for the suctioned asbestos-containing material.

5. (canceled)

6. The cleaning laser assembly according to claim 1, wherein the suction device comprises a filter device, the filter device being designed as a HEPA filter.

7. The cleaning laser device according to claim 6, wherein the filter device comprises a filter vibrating unit which is designed as a manual, mechanically operated filter vibrating unit.

8. The cleaning laser assembly according to claim 1, wherein the suction device is designed as a vacuum suction device.

9. The cleaning laser assembly according to claim 1, wherein the suction device comprises a suction power greater than 3 kW.

10. The cleaning laser assembly according to claim 1, wherein the cleaning laser assembly comprises a housing, the housing being designed in such a way that the cleaning laser remains asbestos-free during the cleaning process.

11. (canceled)

12. The cleaning laser assembly according to claim 1, wherein the cleaning laser assembly comprises a control device comprising a closed loop control functionality, which is configured to automatically adapt a suction flow of the suction device to a parameterization of the cleaning laser.

13. The cleaning laser assembly according to claim 12, wherein the control device is configured to trigger a run-on of the suction device after termination of the cleaning process.

14. The cleaning laser assembly according to claim 1, wherein the cleaning laser assembly comprises a holding device on which the cleaning laser can be arranged so that the latter is always at the same distance from the metallic surface comprising the cover layer.

15. A method for removing an asbestos-containing material cover layer from metallic surfaces during a cleaning process, wherein during the cleaning process an asbestos fiber concentration at the workplace in the layer average is below an asbestos fiber acceptance concentration of 10,000 F/m³ during a cleaning process, wherein the cover layer is removed by means of a cleaning laser assembly which comprises a cleaning laser that emits a laser beam and which comprises a suction device that has a suction opening.

16. The method according to claim 15, wherein the method is a low-emission method according to TRGS 519 in the version of Mar. 31, 2022.

17. The method according to claim 15, wherein during the cleaning process the removed cover layer is sucked in together with the released asbestos-containing material through a suction opening into the suction device.

18. (canceled)

19. (canceled)

20. The method according to claim 15, wherein the power density of the cleaning laser assembly comprises single-pulse powers in the range between 200 kW and 2000 kW and the pulse lengths are in the range from 50 ns to 200 ns.

21. The method according to claim 15, wherein the suction device comprises a filter device, the filter device further comprising a filter vibrating unit which is suitable for cleaning the filter device.

22. The method according to claim 15, wherein the cleaning laser assembly comprises a control device comprising a closed loop control functionality and configured to automatically adapt a suction flow of the suction device to a parameterization of the cleaning laser.

23. The method according to claim 15, wherein the cleaning laser assembly comprises a control device comprising a closed loop control functionality, wherein the control device is configured to trigger a run-on of the suction device after termination of the cleaning process.

24. The method according to claim 23, wherein the run-on time is between 30 s and 10 min.

25. The method according to claim 15, wherein the cleaning laser assembly comprises a control device comprising a closed-loop control functionality, the control device being configured to switch on the suction device when the cleaning laser is switched on.
